(19) United States
(12) Patent Application Publication
(10) Pub. No.: US 2019/0225293 A1
(43) Pub. Date: Jul. 25, 2019

(54) Uni Frame Bike

(71) Applicants: Christopher M. Dupuis, Vero Beach, FL (US); David M. Goeppner, Marretta, GA (US); Michael Kleinheinz, Flowery Branch, GA (US)

(72) Inventors: Christopher M. Dupuis, Vero Beach, FL (US); David M. Goeppner, Marretta, GA (US); Michael Kleinheinz, Flowery Branch, GA (US)

(21) Appl. No.: 15/932,003

(22) Filed: Jan. 22, 2018

(51) Int. Cl. B62K 3/06; B62J 1/12

(52) U.S. Cl. CPC B62K 3/06; B62K 11/02; B62J 1/12

(57) ABSTRACT

The present invention relates to bicycles, and is particularly concerned with bicycles having a ridged mounted seat and step through frame that is designed around the seat. The present invention is a uniframe bicycle with a step through design and a rigid mounted banana style seat pedal forward design.

### RELATED APPLICATIONS

The present application is related to United States patent number US20150001828 A1, issued Jan. 1, 2015, by Gary Silva, included by reference herein.

The Silva patent claims a step through frame with a mechanically attached seat and below the seat peddle position clearly different than the present invention design.

### FIELD OF THE INVENTION

The present invention relates to a bicycle and, more particularly, to a bicycle designed for comfort, reduced maintenance and ability to fit a variety of human sizes and shapes.

### BACKGROUND OF THE INVENTION

Bicycle design has remained nearly the same for over 100 years. The typical design is one of a diamond shape featuring pedals under the rider, a height-adjustable seat and lean-forward ridding position. This design is situated well for speed but not for comfort. The adjustable seat does not always stay adjusted it can easily slip posing a serious injury risk to the rider. It can be stolen and must be moved to accommodate each new rider. In a rental situation this can be many times per day and soon the adjustment hardware is worn out, does not stay adjusted and must be replaced. It requires an on-sight mechanic to make the adjustments and make all the repairs, this adds to maintenance and repair costs.

By having a short seat and the cranks positioned under the seat, the rider is unable to easily adjust their position on the bike and while the bike may fit them correctly, nobody else can safely ride the bike without adjusting the height of the saddle—and this poses risks because the locking mechanism on the saddle is prone to wear out or to not be secured tightly enough and the saddle will drop under the rider's weight—leading to serious injury.

The diamond shape frame is hard for some people to mount and can create a safety problem for smaller riders who are suddenly raised off the ground and cannot reach the ground with their feet while sitting in the bicycle seat which prevents them from stabilizing themselves and prevent falling.

Seats are typically designed to fit a particular size rider do to their size, age or gender. If the seat is not a proper fit it can not only be uncomfortable but may damage the riders body. This may not be a problem in bicycles that always have the same rider and that rider has made the investment into a seat that fits them properly, but it is especially a problem where bicycles are rented out and encounter a multitude of different sized and shaped riders on a daily basis. A rental shop cannot possibly stock enough variety of seats to fit every different rider they will rent to. Nor is it practical to assume that when the rider says the adjustment is correct that it will remain so after a short time ridding.

Diamond shaped frames for male riders have a high center bar requiring the male rider to lift and swing his leg over the frame. This can be a problem for older male riders or male riders with an injury preventing them from achieving normal movement. This design can also prevent a male rider from easily reaching the ground with his feet when stopped creating a possibility of a fall over and resulting injury.

A variety of custom, though expensive, bike seats are available to make the rider more comfortable. These include deep relieve seats, foam filled seats, backed seats, gel filled seats, extra wide seats. There are seats designed specifically for men or women that consider the differences in anatomy between the sexes. The variety of seats is extensive and tries to target the problem of discomfort associated with bicycle riding.

Seat height adjustment helps to reduce discomfort and has existed for a long time to help raise or lower the rider to the most comfortable position with regards to the relationship between seat height and pedal distance. By loosening a tightener to position the seat which is typically mounted or attached to a tube or shaft that is inserted into a slightly large tube allowing for a sliding in or out motion, the seat can be raised or lowered to more perfectly fit the rider.

Step though frames have been used for some time for bicycles designed for female riders but not for male riders.

The most obvious shortcoming is the shear variety of solutions available. In the example of a single rider who owns their own bicycle and rides no other one of the prior solutions may be practical. However, in the case of a rental company, the variety of riders of which many are not avid bike riders, presents and insurmountable problem in providing comfort and or safety to the rider.

Imagine the variety of shapes sizes and genders that wish to rent a bicycle on any given day. Now image how large the ware house would need to be to inventory the immense variety of seats available to provide the customers with the proper seat. Each rider would have to guess at the seat best suited for them and that's not an easy task. One must truly ride with that seat for a period to learn how comfortable or uncomfortable it may be. In addition, the seat height adjustment must be proper providing yet another variable to be adjusted. If the rider is heavy and the seat adjustment worn some the seat may slide downward as the rider travels or suddenly drop upon encountering an unexpected bump.

The possibility of an uncomfortable ride exists simply because of seat issues which could easily result in the rider being unhappy and not taking advantage of the vender's services in the future.

The other factor not addressed by existing solutions is the horizontal relation whip of where the rider sits and the position of the bicycles pedals. Having to lean forward which a diamond shape bicycle frame encourages, can be very uncomfortable for many people.

The diamond design that uses this step through design is easily recognized as a gender specific design causing male riders to shy away from it.

A rental service depends upon the bicycle rider enjoying a leisurely and comfortable ride. They need their customers to enjoy and remember that enjoyment, so they will come back and be repeat customers or share their joy with others bringing in new business. An uncomfortable ride will not produce the desired results.

would be advantageous to provide an easy on/off access by means of a step through frame design of the bike allowing easy on and off without having to lift your leg and the ability to quickly place your feet on the ground to stabilize the bicycle.

It would also be advantageous to provide a seat position that allows for riders of varying heights to use the same size bike.

It would further be advantageous to provide an integrated seat meaning the seat cannot be stolen like an adjustable seat post design can be.

It would further be advantageous to provide an integrated seat, so the user does not have to adjust it to be able to ride the bike.

It would further be advantageous to provide a bicycle, so the rider is behind the bottom bracket, so they are in a more comfortable position and able to be flat footed on the ground when stopped.

### SUMMARY OF THE INVENTION

The present invention relates to bicycles, and is particularly concerned with bicycles having a rigid mounted seat and step through frame that is designed around the seat. The present invention is a uni frame bicycle with a step through design and a rigid mounted banana style seat pedal forward design.

### BRIEF DESCRIPTION OF THE DRAWINGS

A complete understanding of the present invention may be obtained by reference to the accompanying drawings, when considered in conjunction with the subsequent, detailed description, in which:

FIG. 7 is a top detail view of a chain stay. the chain stay provides the mounting location for the rear wheel, drop outs, cable guides and kick stand mount;

FIG. 2 is a rear detail view of a seat stay with cable routing;

FIG. 3 is a top detail view of a mid frame structure that provides strength and mounting platforms;

FIG. 4 is a top detail view of a seat structure. this is an integral part of the frame providing for the seat mounting and adds structure strength to the bicycle;

FIG. 1 is a side perspective view of the assembled uni frame bike frame. showing the seat mounting position. placement of the pedal mounting and step through design;

FIG. 5 is an end sectional view of a seat structure end view showing the elevation profile; and

FIG. 6 is a front partial view of an of the seat structure and its mid frame mounting point.

For purposes of clarity and brevity, like elements and components will bear the same designations and numbering throughout the Figures.

### DESCRIPTION OF THE PREFERRED EMBODIMENT

FIG. 1 is a side perspective view of the entire universal frame bike 8.

FIG. 2 is a rear detail view of a seat stay 82 with cable routing.

FIG. 3 is a top detail view of a mid frame structure 50 that provides strength and mounting platforms.

FIG. 4 is a top detail view of a seat structure 70 an integral part of the frame providing for the seat 68 mounting and adding structure strength to the bicycle.

FIG. 5 is an end sectional of a seat structure 70.

FIG. 6 is a front partial view of the seat structure 70 and its mid frame mounting point.

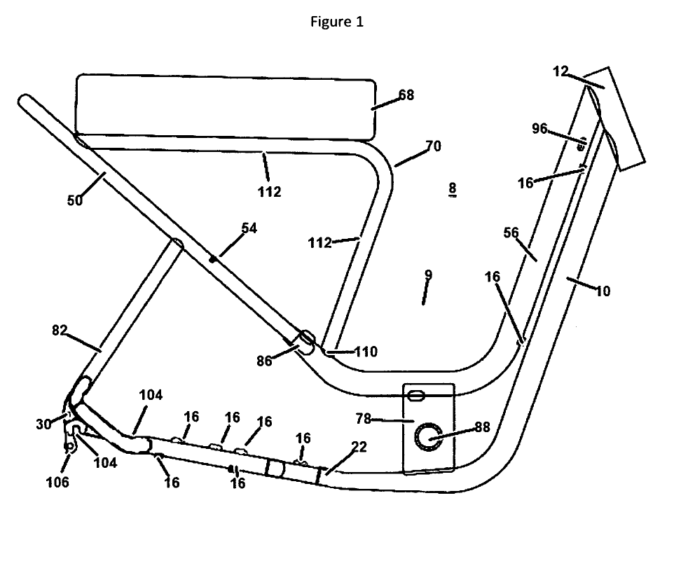

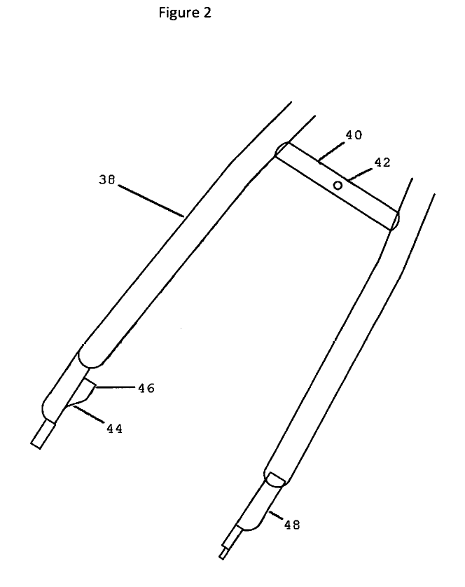

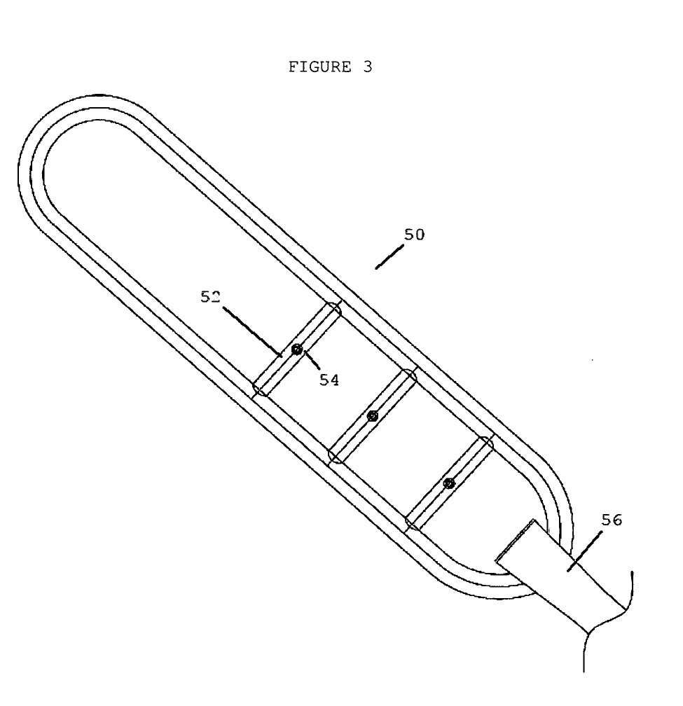

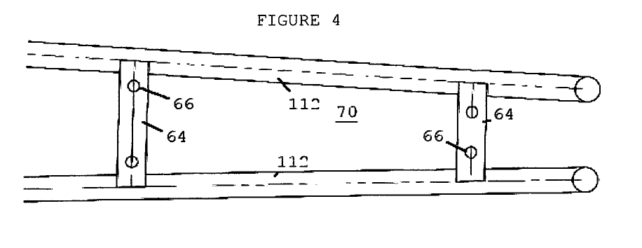

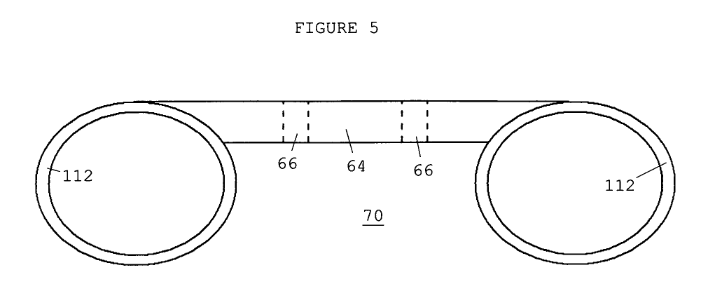

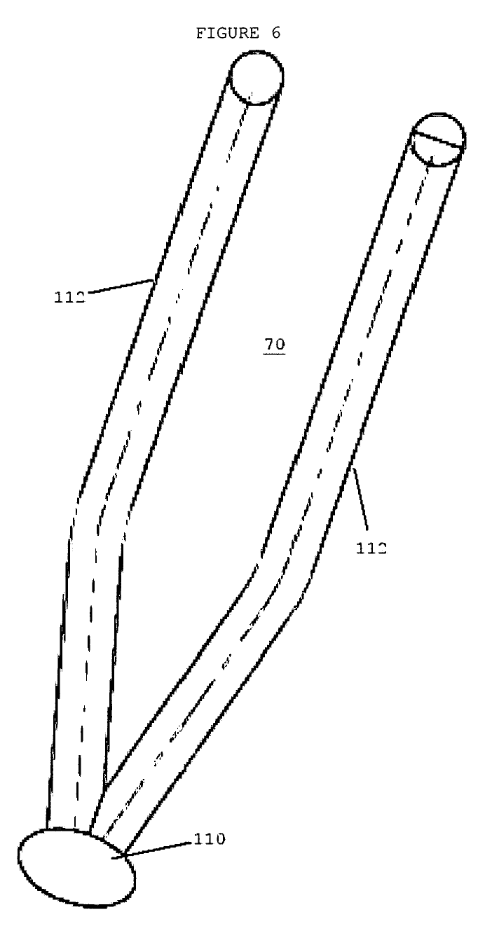

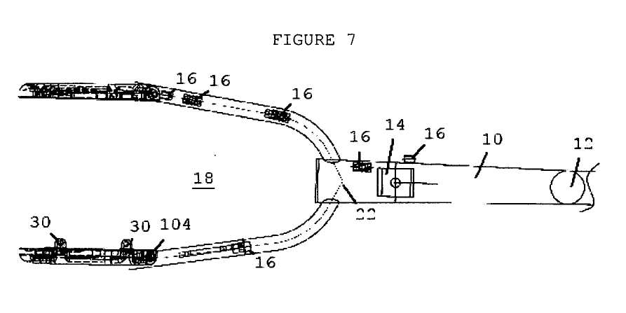

FIG. 7 is a top detail view of the chain stay 18.

Detailed description of FIG. 1; in a preferred embodiment of the present invention there is a universal frame bike 8 (universal meaning that with two different sized frames all sizes of riders can be fit) with a step through area 9 consisting of a down tube 10 head tube 12 cable guide 16 chain stay intersection point 22-disc brake mount 30 mid frame structure 50 battery/bag mount 54 (this design can accommodate a motor 114 to propel the bike with a battery or engine as the power source, not shown. seat 68 top tube 56 seat structure 70 bottom bracket plate 78 seat stay 82 mid frame intersections point 86 bottom bracket shell 88 internal cable guide 96 drop out 104 derailleur hanger 106 kickstand plate 14 disc brake mount 30 and brake mounting hole 42. The universal frame bike 8 consists of rigid tubing in its most preferred embodiment, aluminum or composite tubing would be two examples of preferred materials but any rigid material suitable for the application would be acceptable. The step through area 9 is further formed by means of a generally tubular mid frame structure 50 forming a generally U-shaped opening consisting of a head tube 12 portion on the front side weldably connected to a top tube 56 and a seat structure 70 forming the rear of the generally U-shaped opening and weldably attached to the mid frame structure 50 at the mid frame attachment point 110. This step through area 9 permits the rider to easily place themselves on or off the bike by stepping through the opening and straddling the bike. It further permits a rider to leave the seat 68 and stand with both feet flat on the ground stabilizing the bike and preventing a tipping situation.

The head tube 12 serves as a joining place for the down tube 10 and top tube 56 to be weldably attached and the hollow internal portion of the head tube 12 permits a steering mechanism to be mounted (not shown) in the head tube 12 in a generally vertical position permitting the rotation of the front steering wheel (not shown). A seat structure 70 rises vertically from the mid frame structure 50 and then bends in a generally inverted L shape toward the rear of the frame permanently attached at both ends to the mid frame structure 50 serving as the seat structure 70 permitting the removable mounting of the seat 68 by means of one or more fasteners (not shown). The seat 68 is long and slender allowing the ride to choose a comfortable position on the seat 68 by moving the body rear ward or forward. This permits a at least a 12″ difference in heights between riders without the need for a seat 68 adjustment. A bottom bracket plate 78 weldably attached to the down tube 10 and the top tube 56 adds strength to the entire frame unit providing a mounting place by means of the bottom bracket shell 88 for the peddle mechanism (not shown). A seat 68 is mounted to the seat structure 70 by means of removable fasteners (not shown) and provides a location for the rider to sit if the rider chooses to sit while riding the bike. This location of the seat 68 is to the rear of the bottom bracket shell 88 where the peddles (not shown) are mounted creating an in-front of the seat 68 peddling position as opposed to a directly below peddle position.

A plurality of cable guide 16 bracket (s) are weldably attached to both the mid frame structure 50 and the down tube 10 providing a place where control cables (not shown) for brake and gear shifting applications can be removeably attached. Control handles (not shown) mounted on the steering bars (not shown) permit the rider to activate brakes (not shown) on one or more wheels (not shown) with their hands or to shift speed gears (not shown) as the bikes speed increases or decreases changing the power dynamics needed for a human to power the bike in a forward motion.

The chain stay 18 runs parallel to the chain (not shown) and consists of two parallel horizontal tubes connecting the down tube 10 to the drop out 104 (s). A rear derailleur cable (not shown) is routed along the down tube 10, then along the chain stay 18 to the derailleur hanger 106. The bottom bracket plate 78 weldably connects the chain stay 18 at its intersection with the down tube 10 to the top tube 56 while providing a location for the bottom bracket shell 88 that will house the peddle mechanism (not shown).

Detailed description of FIG. 2 which is a rear view of the seat stay 82. In a preferred embodiment of the present invention a seat stay structure 81 consisting of two parallel seat rails 112 weldably connected perpendicularly by a seat stay bridge 40 form a generally rectangular shaped support brace traveling from the drop out 104 at the bottom of each of the two seat rails 112 in a generally vertical direction terminating at and weldably attached to the mid frame structure 50 at the mid frame attachment point 110. The purpose of the seat stay 82 is to provide additional strength to the universal frame bike 8, especially supporting the rear portion of the mid frame structure where most of the force exerted by the rider on the seat 68 is applied.

FIG. 3; In a preferred embodiment of the present invention is a mid frame structure 50. The mid frame structure 50 is designed to be wide enough to support the seat structure 70 evenly and mate up to the seat 68 width well. The mid frame structure 50 is also made so that the seat 68 stays are welded to it and provide enough tire clearance for the tires. It consists of two tubes weldably connected in a generally rectangular shape with generally rounded ends. At least one mid frame cross brace 52 is placed interiorly to strengthen the mid frame structure 50 and provide for a battery/bag mount. In a second preferred embodiment the universal bike frame could be fitted with a battery and a motor 114 to power the bike (not shown) eliminating the need for human power through peddling. The forward end of the mid frame structure 50 is weldably attached to the down tube 10.

FIG. 4; shows a seat structure 70 in a preferred embodiment of the present invention. The seat structure 70 consists of two seat rails 112 running generally parallel to each other and held in shape by at least one seat mount cross brace 64. The seat mount cross brace 64 is fitted with at least one seat mount bolt hole 66 for removeably attaching the seat 68 to the seat structure 70.

FIG. 5; is an end view of a seat structure 70 showing the seat rails 112 and seat mount cross brace 64 with at least one seat mount bolt hole 66 for seat 68 mounting bolt (s) (not shown).

FIG. 6; is a front partial view of the seat structure 70 and its mid frame attachment point. Showing a partial view of the seat rails 112.

FIG. 7; in a preferred embodiment of the chain stay 18. The chain stay 18 consists of a generally U-shaped tube weldably attached to the down tube 10 which then weldably attaches to the head tube 12 at the other end. The U-shaped tube is the mounting surface for the kickstand plate 14, at least one cable guide 16, disc brake mount 30 and drop out 104 (s). It is also the chain stay intersection point 22. The chain stay 18 provides the bike with a location to mount the rear wheel providing enough clearance for it to fit and operate unencumbered.

While the description describes preferred embodiments, it is understood that other modification could be made and still remain in the scope of the present invention.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An uni frame bike for increasing comfort, fit and safety for a variety of human sizes without adjustment, comprising:
means for providing a rigid frame to mount other portions of the complete bicycle to, such as the wheels, front fork, seat, peddles and operating hardware;
means for allowing the rider easy access on and off the bicycle, permits a rider to place their feet on the ground to stabilize when necessary, rigidly connected to said means for providing a rigid frame to mount other portions of the complete bicycle to, such as the wheels, front fork, seat, peddles and operating hardware;
means for supporting the rider as they sit on the bicycle, so structured that it permits a range of human sizes and genders to find a correct position for best comfort without mechanical adjustment by moving forward or backward on the seat;
means for mounting the bicycle seat in such a manner that it cannot be adjusted and therefore cannot slip; and
means for an option to add a motor to power the bicycle without human power or in combination with human power by means of electrical or another source energy.

2. The uni frame bike in accordance with claim 1, wherein said means for providing a rigid frame to mount other portions of the complete bicycle to, such as the wheels, front fork, seat, peddles and operating hardware comprises a step through, light, strong, rigid, peddle forward of seat mount uni frame bike.

3. The uni frame bike in accordance with claim 1, wherein said means for allowing the rider easy access on and off the bicycle, permits a rider to place their feet on the ground to stabilize when necessary comprises an open step through area.

4. The uni frame bike in accordance with claim 1, wherein said means for supporting the rider as they sit on the bicycle, so structured that it permits a range of human sizes and genders to find a correct position for best comfort without mechanical adjustment by moving forward or backward on the seat comprises a firm, cushioned, water resistant, generally banana shaped, non-adjustable, long slender shape seat.

5. The uni frame bike in accordance with claim 1, wherein said means for mounting the bicycle seat in such a manner that it cannot be adjusted and therefore cannot slip comprises a rigid, strong, non-adjustable, non-slipping seat structure.

6. The uni frame bike in accordance with claim 1, wherein said means for an option to add a motor to power the bicycle without human power or in combination with human power by means of electrical or other source energy comprises a power providing motor.

7. An uni frame bike for increasing comfort, fit and safety for a variety of human sizes without adjustment, comprising:
a step through, light, strong, rigid, peddle forward of seat mount uni frame bike, for providing a rigid frame to mount other portions of the complete bicycle to, such as the wheels, front fork, seat, peddles and operating hardware;
an open step through area, for allowing the rider easy access on and off the bicycle, permits a rider to place their feet on the ground to stabilize when necessary, rigidly connected to said uni frame bike;
a firm, cushioned, water resistant, generally banana shaped, nonadjustable, long slender shape seat, for supporting the rider as they sit on the bicycle, so structured that it permits a range of human sizes and genders to find a correct position for best comfort without mechanical adjustment by moving forward or backward on the seat;
a rigid, strong, non-adjustable, non-slipping seat structure, for mounting the bicycle seat in such a manner that it cannot be adjusted and therefore cannot slip; and
a power providing motor, for an option to add a motor to power the bicycle without human power or in combination with human power by means of electrical or another source energy.

8. An uni frame bike for increasing comfort, fit and safety for a variety of human sizes without adjustment, comprising:
a step through, light, strong, rigid, peddle forward of seat mount uni frame bike, for providing a rigid frame to mount other portions of the complete bicycle to, such as the wheels, front fork, seat, peddles and operating hardware;
an open step through area, for allowing the rider easy access on and off the bicycle, permits a rider to place their feet on the ground to stabilize when necessary, rigidly connected to said uni frame bike;
a firm, cushioned, water resistant, generally banana shaped, nonadjustable, long slender shape seat, for supporting the rider as they sit on the bicycle, so structured that it permits a range of human sizes and genders to find a correct position for best comfort without mechanical adjustment by moving forward or backward on the seat;
a rigid, strong, non-adjustable, non-slipping seat structure, for mounting the bicycle seat in such a manner that it cannot be adjusted and therefore cannot slip; and
a power providing motor, for an option to add a motor to power the bicycle without human power or in combination with human power by means of electrical or another source energy.
